(19) United States
(12) Patent Application Publication
(10) Pub. No.: US 2008/0223664 A1
(43) Pub. Date: Sep. 18, 2008

(54) Method To Increase The Head Rope Life For Single Conveyance Friction Mine Hoists For Deep Shafts

(76) Inventors: Borje Johansson, Vasteras (SE); Sigurd Grimestad, Vasteras (SE)

Correspondence Address: ST. ONGE STEWARD JOHNSTON & REENS, LLC, 986 BEDFORD STREET, STAMFORD, CT, 06905-5619, US

(21) Appl. No.: 12/126,696

(22) Filed: May 23, 2008

Related U.S. Application Data
(63) Continuation of application No. PCT/SE2006/050500, filed on Nov. 22, 2006.
(60) Provisional application No. 60/739,494, filed on Nov. 25, 2005.

(51) Int. Cl. B66B 11/00

(52) U.S. Cl. 187/254

(57) ABSTRACT

The invention relates to a device and system for underground transport of ore, material and people, which includes electrical and mechanical drive systems, a plurality of hoisting devices, head ropes and balance ropes. The mass per meter of the balance ropes is significantly smaller than the mass per meter of the head ropes.

### CROSS-REFERENCE TO RELATED APPLICATIONS

The present application is a continuation of pending International patent application PCT/SE2006/050500 filed on Nov. 22, 2006 which designates the United States and claims benefit under 35 U.S.C. §119 (e) of the U.S. Provisional Patent Application Ser. No. 60/739,494 filed on Nov. 25, 2005. All prior applications are herein incorporated by reference in their entirety.

### FIELD OF THE INVENTION

The present invention concerns a method and device to increase the head rope life for single conveyance friction hoists for deep shafts.

### BACKGROUND OF THE INVENTION

A friction mine hoist, which may be of the double or of the single conveyance type, may be characterized by a pulley with friction liners, or similar, grooved to the diameter of the head ropes. The conveyances (skip or cage) for a double friction hoist are carried by the head rope(s) with the head ropes laid over the pulley with a contact angle of about 180 degrees. The rope ends are secured to the conveyances. The friction between the head rope(s) and the friction liners allows for a certain difference in rope tension of the two sides of the pulley without the occurrence of rope slip. Balance/Tail rope(s) are attached under the conveyances to limit the difference in rope tension between the two sides of the pulley. Traditionally the mass per meter of the balance ropes has been dimensioned to be equal or nearly equal to the mass per meter of the head ropes. Thereby the safety margin before rope slip occurs is independent of the position in the shaft of the two conveyances.

A single friction hoist is based on the same principle as a double friction hoist, but with the difference that one of the conveyances is replaced by a counterweight. The mass of the counterweight is normally selected to be equal to the conveyance mass plus 50% of the net load. Thereby the difference in rope tension between the two sides of the pulley at empty conveyance and normal net load will be the same. Friction mine hoists can be ground mounted with head sheaves in the head frame or tower mounted with or without deflection sheaves.

The static load variations in the head ropes occur as a result of loading the conveyance at the lower stop level and then hoisting it to the unloading (dumping) level at the upper end of the shaft whereby the balance rope(s) add mass to the ascending conveyance side, so adding rope tension in the head rope(s). The load variations can either be expressed as differences in tension (MPa or psi) or as load variations in percent of the breaking load of the head rope(s).

The life of the head ropes of a mine hoist of the friction hoist type depends on several factors such as:
load distribution between the ropes in case of multi-rope arrangement
diameter ratio between the pulley and the ropes and between deflection sheaves or head sheaves and the ropes
the rope construction and wire tensile strength
the breaking strength of the rope
rope oscillations at loading and dumping (release) of the load
longitudinal and transverse rope oscillations
quasi stationary loads under acceleration and retardation
static load variations in particular near the rope ends (Static Load Range)

Acceptable rope life is normally obtained for friction hoists in installations with hoisting distances up to 1400 to 1500 m by adopting applicable mine hoist regulations and good engineering practice.

At hoisting distances in excess of 1400 to 1500 m using friction hoists, the Static Load Range (SLR) increases to be the dominating factor determining the head rope life.

Thereby, the SLR i.e. the maximum static load variation at the rope ends in percent of the rope breaking strength determines the limit for the practical/economical maximum hoisting distance for friction hoists. The SLR can be expressed by using the following equation:

SLR (%)=(Nl+(z2*q2*H))*g*100/(z1*B) where
Nl=Net load (kg)
z2=the number of balance ropes
q2=the total mass of the balance ropes (kg/m)
H=the hoisting distance (m)
g=9.81 (m/s2)
z1=the number of head ropes
B=the breaking strength for the head ropes (N)

### SUMMARY OF THE INVENTION

The load variation caused by the mass of the balance ropes is dominating in friction hoists over large hoisting distances. The technical solution for reducing the static load variations for single conveyance friction hoists is to reduce the mass per meter of the balance ropes instead of the traditional practice to keep the mass equal or close to the mass per meter of the head ropes.

An embodiment of the present invention provides an improvement to considerably reduce the Static Load Range (SLR) while maintaining required margin before rope slip. Thereby the hoisting distance and/or the net loads can be significantly increased, and the lifetime for the head ropes can be significantly increased. Alternative solutions for single conveyance friction hoists are not known.

### BRIEF DESCRIPTION OF THE DRAWINGS

Embodiments of the invention will now be described, byway of example only, with particular reference to the accompanying drawings in which:

FIG. 1 shows a simplified diagram of a system comprising a friction mine hoist according to an embodiment of the invention.

FIG. 2 shows a simplified diagram of a system comprising a friction mine hoist with an empty conveyance in the lowest position.

FIG. 3 shows a simplified diagram of a system comprising a friction mine hoist with a loaded conveyance in the lowest position.

FIG. 4 shows a simplified diagram of a system comprising a friction mine hoist with a loaded conveyance in the highest position.

FIG. 5 shows a simplified diagram of a system comprising a friction mine hoist with an empty conveyance in the highest position.

### DETAILED DESCRIPTION OF THE INVENTION

The following example illustrates the advantage of the solution of the invention:

Good engineering practice is to limit the SLR to at least 11.5% of the breaking strength of the head ropes. Taking this value as criteria for acceptable load variation illustrates the advantage of the solution:
Head ropes: 4×56 mm² of certain construction and breaking load
Static Load Range: 11.5%

Conveyance mass: Equal to the net load

Possible net load (kg)

| Hoisting distance | | Balance rope mass as |
|---|---|---|
| (m) | Rope balance | per the invention |
| 1 700 | 28 538 | 57 764 |
| 1 800 | 22 776 | 45 275 |
| 1 900 | 17 018 | 33 583 |
| 2 000 | 11 259 | 22 129 |

Balance ropes are also known as tail ropes.

Required rope safety factor

| Hoisting distance | | Balance rope mass as |
|---|---|---|
| (m) | Rope balance | per the invention |
| 1 700 | 6.99 | 5.15 |
| 1 800 | 7.26 | 5.60 |
| 1 900 | 7.54 | 6.15 |
| 2 000 | 7.85 | 6.80 |

Head ropes and conveyance mass as above

| | | SLR (%) | |
|---|---|---|---|
| Hoisting distance | Rope safety | | Balance rope mass |
| (m) | factor | Rope balance | as per the invention |
| 1500 | 6.0 | 12.17 | 10.01 |
| 1600 | 6.0 | 12.43 | 10.41 |
| 1700 | 6.0 | 12.70 | 10.80 |
| 1800 | 6.0 | 12.96 | 11.19 |
| 1900 | 6.5 | 12.57 | 11.26 |
| 2000 | 7.0 | 12.28 | 11.38 |

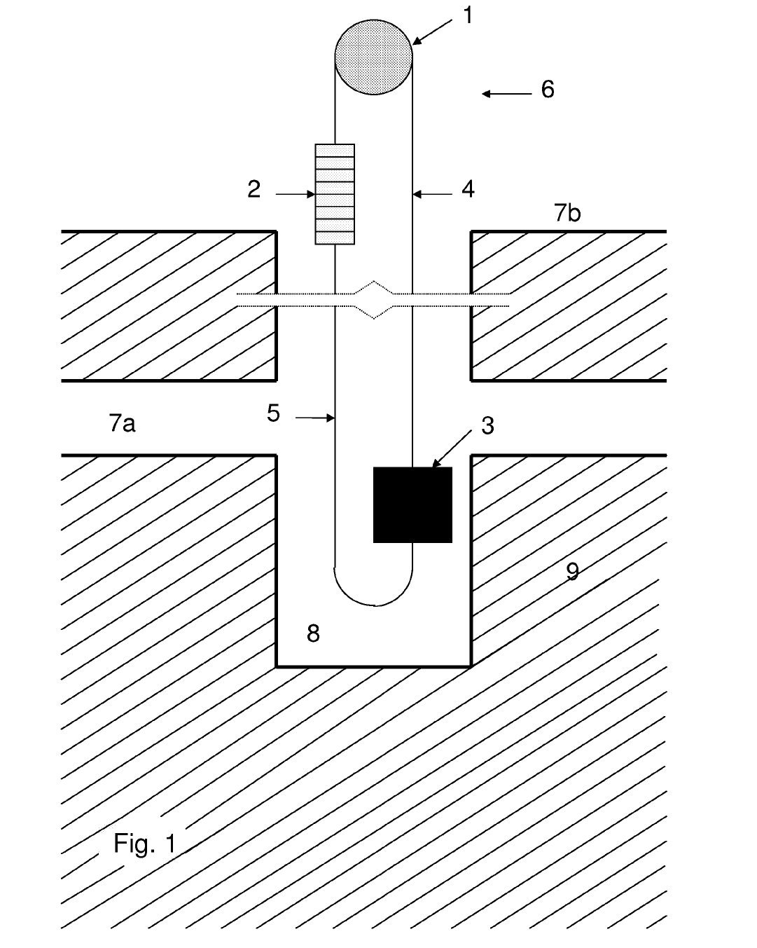

FIG. 1 shows a friction mine hoist (6) in a deep shaft (8) in the ground (9), the shaft having at least two levels (7a, 7b) for loading and unloading of ore, materials and personnel, the hoist comprising a pulley (1), a counterweight (2), a conveyance (3), head ropes (4) and balance ropes (5).

The static rope tension acting on the head ropes, may for example be calculated at 4 critical points (A, B, C and D), and at four different times (t1, t2, t3, and t4) which depend on the position of the conveyance and if the conveyance is unloaded or loaded, according to the following equations:

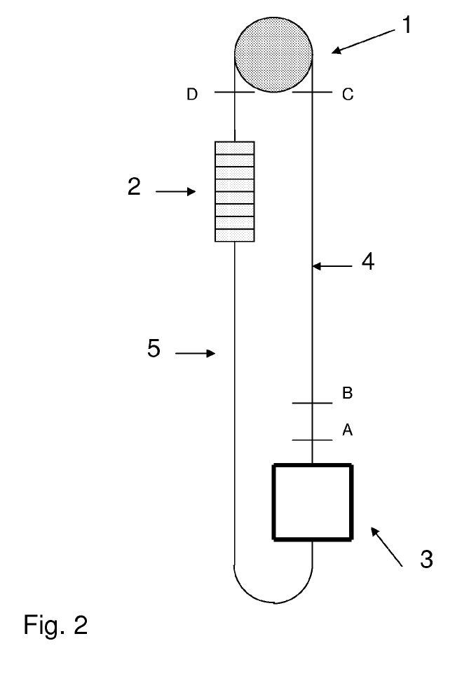

FIG. 2:
When t=t1 (unloaded conveyance in lowest position)

At point A: F=Sk*g

At point B: F=Sk*g

At point C: F=(Sk+Lv1)*g

At point D: F=(Mv+Lv2)*g
where
F=the calculated static rope tension (N)
Sk=Conveyance mass (kg)
g=9.81 m/s2
Mv=Counterweight mass (=Sk+0.5*Nl) where Nl=Net load (kg)
Lv1=the total mass of the head ropes (kg)
Lv2=the total mass of the balance ropes (kg)

Due to the large hoisting distance the mass of the upper and bottom part of the rope loops, as well as the rope mass between the points A and B, can be neglected.

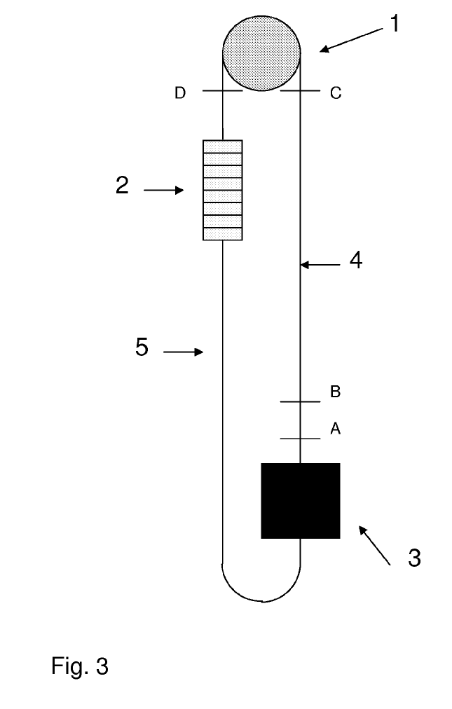

FIG. 3:
When t=t2 (loaded conveyance in lowest position)

At point A: F=(Sk+Nl)*g

At point B: F=(Sk+Nl)*g

At point C: F=(Sk+Nl+Lv1)*g

At point D: F=(Mv+Lv2)*g
where
Nl=Net load (kg)
Mv=Counterweight mass (kg)
Other definitions as described above at t1.

Due to the large hoisting distance the mass of the upper and bottom part of the rope loops, as well as the rope mass between the points A and B, can be neglected.

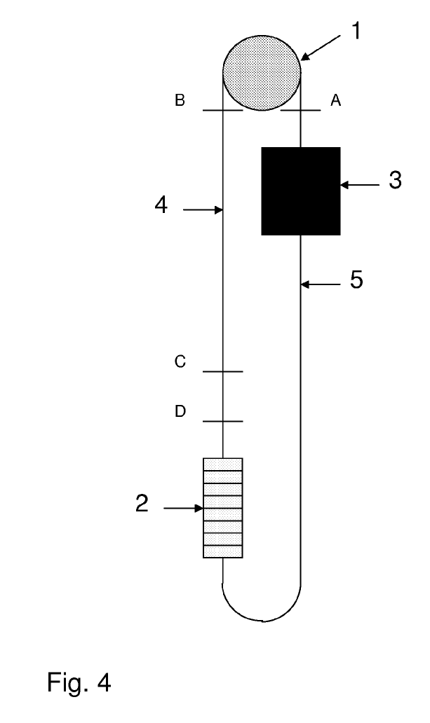

FIG. 4:
When t=t3 (loaded conveyance in highest position)

At point A: F=(Sk+Nl+Lv2)*g

At point B: F=(Mv+Lv1)*g

At point C: F=Mv*g

At point D: F=Mv*g
Definitions as described above at t1 and t2.

Due to the large hoisting distance the mass of the upper and bottom part of the rope loops, as well as the rope mass between the points C and D, can be neglected.

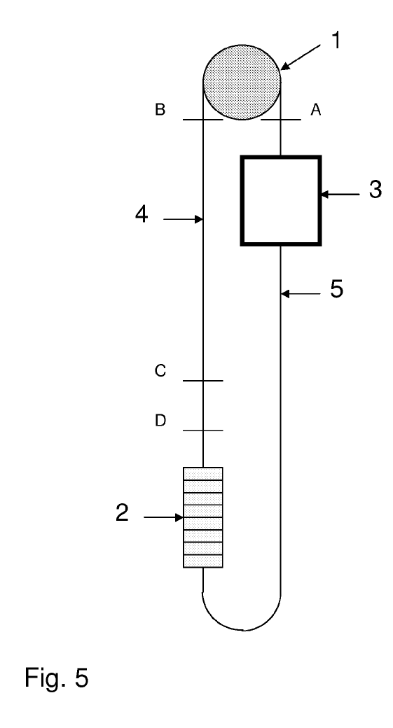

FIG. 5:
When t=t4 (unloaded conveyance in highest position)

At point A: F=(Sk+Lv2)*g
At point B: F=(Mv+Lv1)*g
At point C: F=Mv*g
At point D: F=Mv*g

Definitions as described above at t1 and t2.

Due to the large hoisting distance the mass of the upper and bottom part of the rope loops, as well as the rope mass between the points C and D, can be neglected.

According to the equations mentioned above the load tension variations in critical points (A, B, C and D) can be calculated according to the following equations:

Point A: (Sk+Nl+Lv2)*g−Sk*g=(Nl+Lv2)*g

Point B: (Mv+Lv1)*g−Sk*g=(Sk+0.5*Nl+Lv1−Sk)*g=(Lv1+0.5*Nl)*g

Point C: (Sk+Nl+Lv1)*g−Mv*g=(Sk+Nl+Lv1−Sk−0.5*Nl)*g=(Lv1+0.5*Nl)*g

Point D: (Mv+Lv2)*g−Mv*g=Lv2*g

Minimum rope tension variation appears when the variation in point

A is equal to variation in point B, thus

(Nl+Lv2)*g=(Iv1+0.5*Nl)*g=>Lv2=Lv1−0.5*Nl
this will give the following variations:

Point A: (Nl+Lv1−0.5*Nl)*g=(Lv1+0.5*Nl)*g

Point B: (Lv1+0.5*Nl)*g

Point C: (Lv1+0.5*Nl)*g

Point D: Lv2*g=(Lv1−0.5*Nl)*g

The optimum balance rope mass per meter is calculated with the following equation:

q2=(z1*q1*H−0.5*Nl)/(z2*H)
where
q2 is the balance rope mass (kg/m)
z1 is the number of head ropes
q1 is the head rope mass (kg/m)
H is the hoisting distance (m)
z2 is the number of balance ropes

At optimum balance rope mass the SLR is reduced by the value defined by the following equation:

Δ SLR (%)=0.5*Nl*g*100/(z1*B)

It should be noted that while the above describes exemplifying embodiments of the invention, there are several variations and modifications which may be made to the disclosed solution without departing from the scope of the present invention as defined in the appended claims.

1. A hoisting device for underground transport comprising electrical and mechanical drive systems, a plurality of hoisting devices, head ropes and balance ropes, characterized in that the mass per meter of the balance ropes is smaller than the mass per meter of the head ropes.

2. The device according to claim 1, characterized in that the mass per meter of the balance ropes is significantly smaller than the mass per meter of the head ropes.

3. The device according to claim 1, characterized in that the mass per meter of the balance ropes is significantly smaller that the mass per meter of the head ropes and approaches a value of:
q2=(z1*q1*H−0.5*Nl)/(z2*H).

4. (canceled)

5. A hoisting system for underground transport comprising electrical and mechanical drive systems, a plurality of hoisting devices, head ropes and balance ropes, characterized in that the mass per meter of the balance ropes is smaller than the mass per meter of the head ropes.

6. The device according to claim 2, characterized in that the mass per meter of the balance ropes is significantly smaller that the mass per meter of the head ropes and approaches a value of:
q2=(z1*q1*H−0.5*Nl)/(z2*H).

7. Method of making an underground transport system comprising the steps of:
providing at least one hoisting device; and
selecting head ropes and balance ropes for the hoisting device;
wherein a mass per meter of the balance ropes is smaller than a mass per meter of the head ropes.

8. The Method of claim 7 wherein the selecting step further comprises:
selecting balance ropes with a significantly smaller mass per meter measurement than the mass per meter measurement of the head ropes.

9. The method of claim 7 wherein the selecting step further comprises:
selecting balance ropes with a mass per meter which approaches the value of:
q2=(z1*q1*H−0.5*Nl)/(z2*H).

10. Method of using an underground transport system comprising the steps of:
providing a plurality of hositing devices;
selecting head ropes with a significantly larger mass per meter measurement than the mass per meter measurement of balance ropes;
adding material to the hoisting devices; and
transporting the material underground.
